(19) United States
(12) Patent Application Publication
(10) Pub. No.: US 2009/0077183 A1
(43) Pub. Date: Mar. 19, 2009

(54) SYSTEM AND METHOD OF UPDATING AN EVENT SCHEDULE VIA ELECTRONIC MAIL BASED ON A USER'S CALENDER SETTINGS

(76) Inventors: Afua Asantewa Bruce, Austin, TX (US); Oluwaseyi Olabamipe Oyerokun, Midland, TX (US); Robert Vernon Williamson, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/857,080

(22) Filed: Sep. 18, 2007

(51) Int. Cl. G06F 15/16

(52) U.S. Cl. 709/206

(57) ABSTRACT

A method, system and computer program product for associating automated electronic mail (e-mail) with a calendar of events. A sender utilizes an automated e-mail to notify an event's scheduled attendees that the sender is out of office. When utilizing options within a mail user agent, a user may select a set of calendar days in which the user is not available for events. The mail user agent, associated with the user's calendar of events, displays one or more events conflicting with the selected days the user is not available. The e-mail addresses of one or more attendees associated with the conflicting event are dynamically linked to the automated message. The sender may input a text message informing owners, all attendees, and/or select attendees of the sender's absence.

### BACKGROUND

1. Technical Field

The present invention generally relates to electronic communications and in particular to selectively transmitting electronic mail messages.

2. Description of the Related Art

More and more frequently computer users depend on electronic mail (e-mail) to communicate. Whether in the corporate, political, scientific, or personal arena, communication via e-mail messages have become a common aspect of life. Quite frequently, selective automatic e-mail messages such as the “Out of office” standard reply are utilized to remind or inform the sender of an e-mail that the recipient of the e-mail is currently not in the office. The “Out of office” message often states that the recipient of the e-mail will return to the office on a specific date and/or time. The “Out of office” e-mail option is extremely valuable and helpful to people around the globe; however, simply replying with an “Out of the office” message and a date of return is not sufficient to all users or situations.

The “Out of the office” message is a standard reply e-mail that may be automatically sent as a reply e-mail to all incoming e-mails. A selection in the mail user agent's (MUA's) options menu allows a user to turn the “Out of office” option on or off, as well as attach a text message. When the “Out of office” option is turned on, the same automatic message is sent as a reply to all senders of e-mails received at the user's MUA. However, the “Out of office” message is only sent as a reply to a received email, and as such, the “Out of office” message is useless in informing persons who have not sent an e-mail to the particular user's MUA of the user's “Out of office” status.

### SUMMARY OF ILLUSTRATIVE EMBODIMENTS

Disclosed are a method, system and computer program product for associating automated electronic mail (e-mail) with a calendar of events. A sender utilizes an automated e-mail to notify an event's scheduled attendees that the sender is out of office. When utilizing options within a mail user agent, a user may select a set of calendar days in which the user is not available for events. The mail user agent, associated with the user's calendar of events, displays one or more events conflicting with the selected days the user is not available. The e-mail addresses of one or more attendees associated with the conflicting event are dynamically linked to the automated message. The sender may input a text message informing owners, all attendees, and/or select attendees of the sender's absence.

In one embodiment, the options menu interface within a mail user agent is displayed. Shown within the options menu interface is an opportunity to select days in which a user is not available. Following the selection of days, any previously scheduled events which conflict with the days in which the user is not available are automatically displayed. When the events are displayed the user has the opportunity to update the meeting schedule. The user may individually select which events to modify or choose to “select all events”.

In one embodiment, when a user elects to select events that conflict with the days in which the user is not available, a graphical user interface (GUI) is displayed. For each event selected, the GUI presents a choice of groups to notify. The user may choose to notify all attendees of the event, the event organizers (e.g. chair(s), owner, manager), or independently select individuals to notify. When the selection(s) is made, the e-mail addresses of the selected individuals are dynamically linked to the automated e-mail.

In one embodiment, a text box is displayed with each event that is to be updated. The text box may be utilized to cancel or reschedule an event or to update the user's attendance status (e.g. decline attendance, verify attendance, or reschedule). After each field has been updated, the user may send the automated e-mail.

Conveniently sending automated messages for select situations, to select individuals, or groups, increases effective time management and communication. For example, automatically updating scheduled meetings according to one's out of office schedule could be highly effective in any arena of e-mail communication.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a diagram of an example data processing system, according to one embodiment of the invention;

FIG. 2 is a diagram of a network of computers in accordance with one embodiment of the invention;

FIG. 3 illustrates a graphical user interface for out of office e-mail update options according to one embodiment of the invention;

FIG. 4 illustrates a graphical user interface for sending automated out of office e-mail updates in accordance with one embodiment of the invention;

FIG. 5 illustrates a graphical user interface for selecting attendees to send an automated out of office e-mail according to one embodiment of the invention;

FIG. 6 illustrates a graphical user interface for notifying multiple groups when sending out of office e-mail updates in accordance with one embodiment of the invention;

FIG. 7 is a logic flow chart illustrating implementation of the automated e-mail update utility to initiate an automated e-mail message in accordance with one embodiment of the invention; and

FIG. 8 is a logic flow chart illustrating implementation of the automated e-mail update utility to create and send an automated e-mail message in accordance with one embodiment of the invention.

### DETAILED DESCRIPTION OF AN ILLUSTRATIVE EMBODIMENT

The illustrative embodiments provide a method, system and computer program product for associating automated electronic mail (e-mail) with a calendar of events. A sender utilizes an automated e-mail to notify an event's scheduled attendees that the sender is out of office. When utilizing options within a mail user agent, a user may select a set of calendar days in which the user is not available for events. The mail user agent, associated with the user's calendar of events, displays one or more events conflicting with the selected days the user is not available. The e-mail addresses of one or more attendees associated with the conflicting event are dynamically linked to the automated message. The sender may input a text message informing owners, all attendees, and/or select attendees of the sender's absence.

In the following detailed description of exemplary embodiments of the invention, specific exemplary embodiments in which the invention may be practiced are described in sufficient detail to enable those skilled in the art to practice the invention, and it is to be understood that other embodiments may be utilized and that logical, architectural, programmatic, mechanical, electrical and other changes may be made without departing from the spirit or scope of the present invention. The following detailed description is, therefore, not to be taken in a limiting sense, and the scope of the present invention is defined only by the appended claims.

Within the descriptions of the figures, similar elements are provided similar names and reference numerals as those of the previous figure(s). The specific numerals assigned to the elements are provided solely to aid in the description and not meant to imply any limitations (structural or functional) on the invention.

It is understood that the use of specific component, device and/or parameter names are for example only and not meant to imply any limitations on the invention. The invention may thus be implemented with different nomenclature/terminology utilized to describe the components/devices/parameters herein, without limitation. Each term utilized herein is to be given its broadest interpretation given the context in which that terms is utilized.

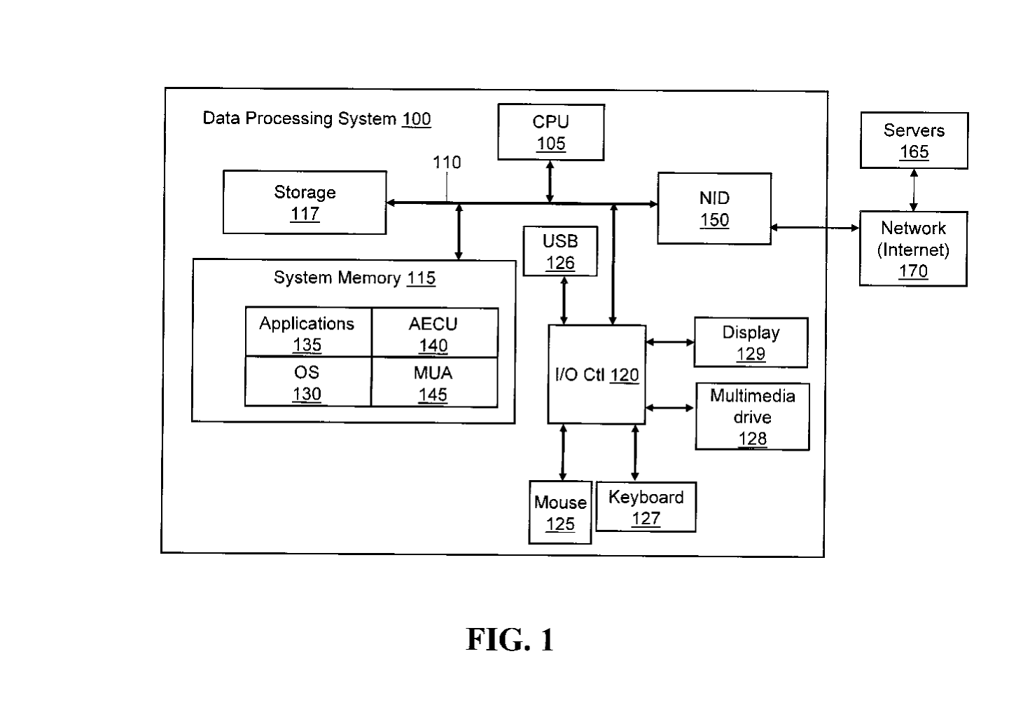

With reference now to the figures, FIG. 1, there is depicted a block diagram representation of a data processing system (and connected network). DPS 100 comprises at least one processor or central processing unit (CPU) 105 connected to system memory 115 via system interconnect/bus 110. Also connected to system bus 110 is I/O controller 120, which provides connectivity and control for input devices, of which pointing device (or mouse) 125 and keyboard 127 are illustrated, and output devices, of which display 129 is illustrated. Additionally, a multimedia drive 128 (e.g., CDRW or DVD drive) and USB (universal serial bus) hub 126 are illustrated, coupled to I/O controller 120. Multimedia drive 128 and USB hub 126 may operate as both input and output (storage) mechanisms. DPS 100 also comprises storage 117, within which data/instructions/code may be stored.

DPS 100 is also illustrated with a network interface device (NID) 150, with which DPS 100 connects to one or more servers 165 via an access network, such as the Internet 170. In the described embodiments, Internet 170 is a worldwide collection of networks and gateways that utilize the Transmission Control Protocol/Internet Protocol (TCP/IP) suite of protocols to communicate with one another. Of course, network access may also be provided via a number of different types of networks, such as an intranet, a local area network (LAN), a virtual private network (VPN), or other wide area network (WAN) other than the Internet.

Notably, in addition to the above described hardware components of DPS 100, various features of the invention are completed via software (or firmware) code or logic stored within system memory 115 or other storage (e.g., storage 117) and executed by CPU 105. Thus, illustrated within system memory 115 are a number of software/firmware components, including operating system (OS) 130 (e.g., Microsoft Windows®, a trademark of Microsoft Corp, or GNU®/Linux®, registered trademarks of the Free Software Foundation and The Linux Mark Institute), applications 135, mail user agent (MUA) 145, such as Eudora™, IBM Lotus Notes™, Microsoft Outlook™, or Outlook Express™, and automated e-mail calendar update (AECU) utility 145. In actual implementation, MUA 145, and AECU utility 140 may be combined as a single application collectively providing the various functions of each individual software component when the corresponding code is executed by CPU 105. For simplicity, AECU utility 140 is illustrated and described as a stand alone or separate software/firmware component, which operate in conjunction with MUA 145 to provide specific functions, as described below.

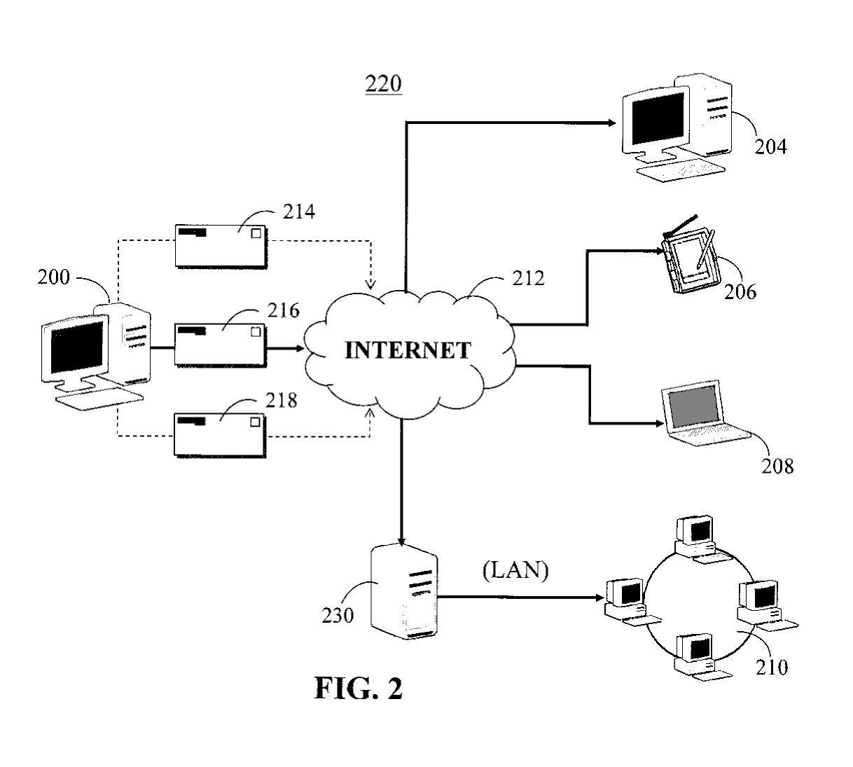

CPU 105 executes AECU utility 140, MUA 145, and OS 130, which supports the user interface features of AECU utility 145 and MUA 145. In the illustrative embodiment, AECU utility 140 provides several graphical user interfaces (GUI) to enable user interaction with, or manipulation of, the functional features of the utility (140). Among the software code/instructions provided by AECU utility 140, and which are specific to the invention, are: (a) code for displaying a graphical user interface for composing one or more e-mails for automated delivery; (b) code for linking one or more recipients to an automated, outgoing e-mail; and (c) code for selectively sending one or more automated e-mails to update an event schedule. For simplicity of the description, the collective body of code that enables these various features is referred to herein as AECU utility 140. According to the illustrative embodiment, when CPU 105 executes AECU utility 140, DPS 100 initiates a series of functional processes that enable the above functional features as well as additional features/functionality, which are described below within the description of FIGS. 2-8.

Those of ordinary skill in the art will appreciate that the hardware and basic configuration depicted in FIG. 1 may vary. For example, other devices/components may be used in addition to or in place of the hardware depicted. The depicted example is not meant to imply architectural limitations with respect to the present invention. The data processing system depicted in FIG. 1 may be, for example, an IBM eServer pSeries system, a product of International Business Machines Corporation in Armonk, N.Y., running the Advanced Interactive Executive (AIX) operating system or LINUX operating system.

With reference now to FIG. 2, network 220 comprises client DPS 200, which sends e-mail X 214, e-mail Y 216, and e-mail Z 218 via Internet 212, to one or more recipient devices, recipient DPS 204, recipient hand-held device 206 (e.g. PDAs, cellular phones, Blackberry™, and other such devices capable of providing/executing an MUA for sending and receiving e-mails). These devices may be recipient laptop 208, or client network 210 via MUA server 230. Computer systems 200 and 204 may be configured similar to data processing system 100 of FIG. 1. A first group of recipient devices (204, 206, 208) receive e-mails from MUA server 230 via Internet 212. A next group of recipient devices, namely devices within network 210 directly connects with MUA server 230 within a local area network (LAN).

In one embodiment, the invention provides a method for simultaneously sending one or more e-mail messages to one or more recipients. Specifically, a sender utilizes an automated e-mail functionality to notify attendees of a scheduled event that the sender is out of office during that scheduled time. In one embodiment, client computer 200 has a MUA 145 (FIG. 1) such as Eudora™, IBM Lotus Notes™, Microsoft Outlook™, or Outlook Express™ that is dynamically linked to the MUA calendar (or a calendar within the software applications of client computer 200). From the options menu of the MUA on client computer 200, e-mail X 214, e-mail Y 216, and e-mail Z 218 are created utilizing the same GUI. E-mail X 214, e-mail Y 216, and/or e-mail Z 218 may be received by recipient DPS 204, recipient hand-held device 206, recipient laptop 208, and/or client network 210. The e-mails are composed allowing the sender to cancel, reschedule, and/or update meeting attendance.

E-mail X 214, e-mail Y 216, and e-mail Z 218 represent automated e-mails sent out for the three different events. From a menu within the MUA on client computer 200, an option is selected to update events (or meetings) scheduled within a specified period of time. When the time period is selected, three meetings are displayed on the GUI. Each event is selected to be updated. The automated e-mails (214, 216, 218) may be delivered according to a specified delivery date or directly after the message has been created.

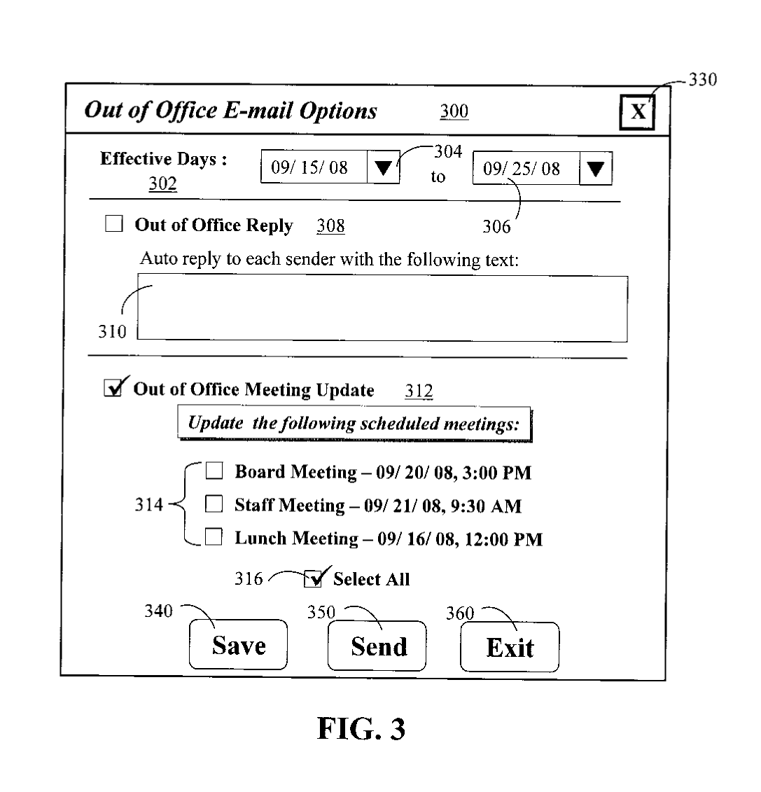

FIG. 3 illustrates out of office options GUI 300. Out of office options GUI 300 is utilized to select out of office days, and to select the events to be updated utilizing automated e-mail. Out of office options GUI 300 comprises effective days 302, wherein start date 304 and end date 306 may be selected as the days in which the sender is not available for scheduled events or meetings. When engaging out of office reply 308, a uniform message may be sent via text box A 310 as an automated reply to e-mails sent to the client during the period of unavailability. Out of office meeting update 312 automatically displays the events scheduled on and between start date 304 and end date 306. Event list 314 displays each event as well as the date and time of the event. Clients may choose to individually select the event, or utilize select all 316, which chooses all events in which to send an automated e-mail update. Save 340 allows the client to save information that has been input into out of office options GUI 300. The automated e-mail messages may be sent by engaging send 350. However, the sender may depart from out of office options GUI 300, with or without saving the entered information, by selecting exit 360. Close 330 may be utilized to close out of office options GUI 300.

In one embodiment, a client enters the days of unavailability utilizing start date 304 and end date 306. Effective days 302 may be entered utilizing a drop down menu or by manually inputting the dates. Following entry of start date 304 and end date 306, events scheduled on a calendar linked to the MUA, on or within effective days 302, are retrieved and automatically displayed. Within the example, out of office e-mail options GUI 300, event list 314 displays three meetings. As illustrated, the client elects to update one or more attendees of all meetings listed, therefore select all 316 is chosen.

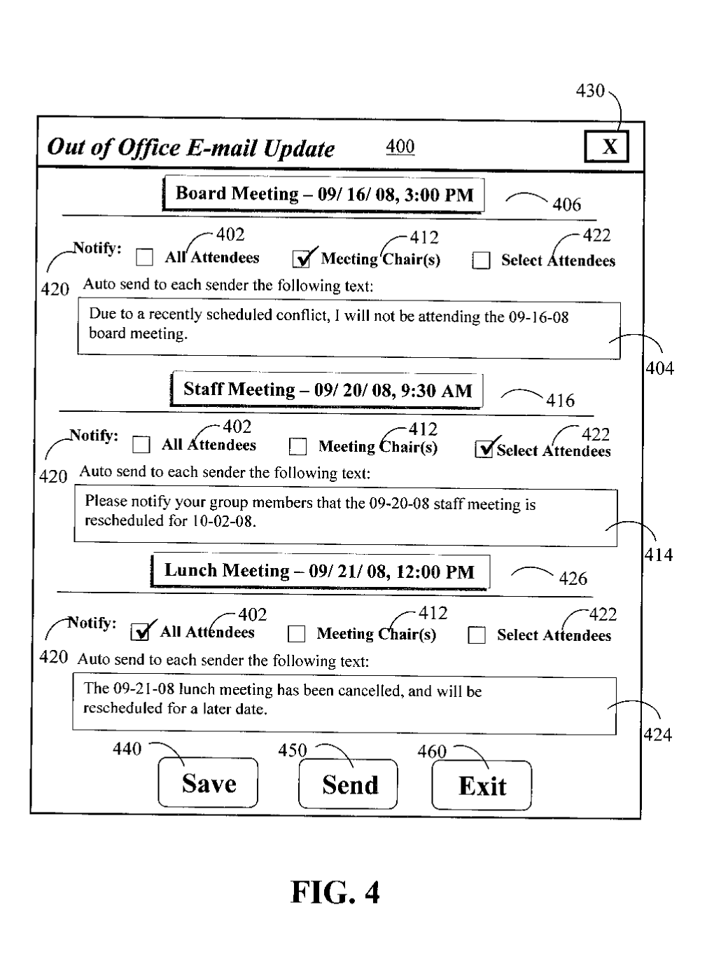

After choosing select all 316, out of office e-mail update GUI 400 (FIG. 4) is displayed. Office e-mail update GUI 400 comprises three sections for the three events listed in event list 314 (FIG. 3), board meeting 406, staff meeting 416, and lunch meeting 426. Each section of office e-mail update GUI 400 is composed of a text box (text box X 404, text box Y 414, and text box Z 424) and notify option 420, from which all attendees 402, meeting chairs 412, and/or select attendees 422 may be selected. After all messages are prepared, send 440 is utilized to simultaneously send the automated e-mail messages to individuals selected in out of office e-mail update GUI 400.

In one embodiment, within out of office e-mail update GUI 400, the client elects to only update meeting chair(s) 412 of board meeting 406. When meeting chair(s) 412 is selected, an e-mail is dynamically composed to be forwarded to all attendees listed as chair of the meeting. E-mail addresses are linked to the automated e-mail from the calendar or address book of the MUA. The client may enter a message in text box X 404 with information to reschedule or cancel attendance.

In one embodiment, all attendees 402 is selected to be updated of a change in the schedule of lunch meeting 426. The e-mail address of each attendee is linked to the e-mail that is dynamically composed. The message within text box Z 424 is forwarded to all attendees schedule to be present at the meeting.

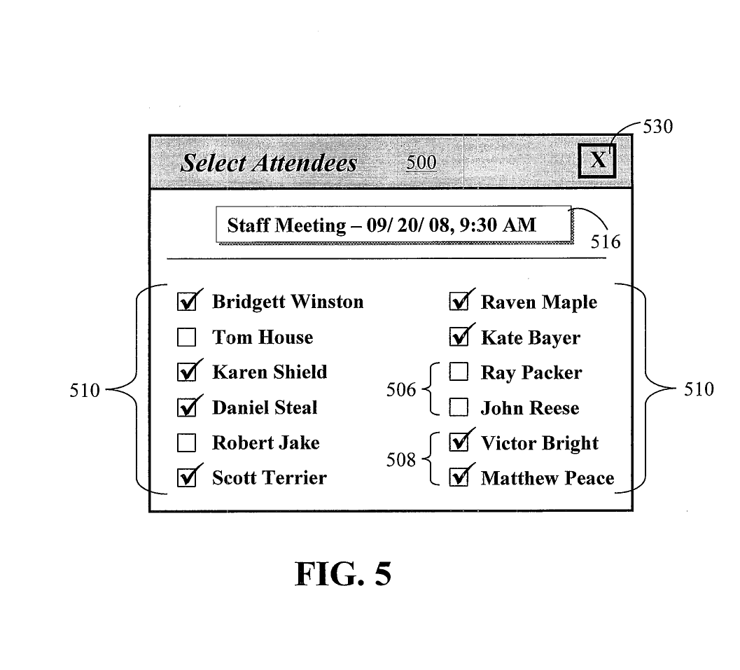

In one embodiment, select attendees 422 is chosen to be notified of a modification in the schedule of staff meeting 416. When select attendees 422 is chosen, select attendees GUI 500 (FIG. 5) is displayed. Select attendees GUI 500, illustrated in FIG. 5, comprises the title, date and time of the event of interest, or staff meeting 516, and list of attendees 510. Within list of attendees 510, selected attendees 508 may be identified via a check mark, and non-selected attendees 506 have no selection indication. When the selection of attendees is complete select attendees GUI 500 may engage save 540 to store information entered into select attendees GUI 500, and then select exit 560 to return to office e-mail update GUI 400. After a message is entered into text box Y 414, the sender may engage save 440 to store the information, and then send 460 may be engaged to distribute the e-mail messages to only those attendees selected in select attendees GUI 500. The sender may also maintain the option to save the entered information without sending, and engaging exit 460 to depart from the office e-mail update GUI 400. Engaging close 430 will close office e-mail update GUI 400 without sending the automated e-mail messages.

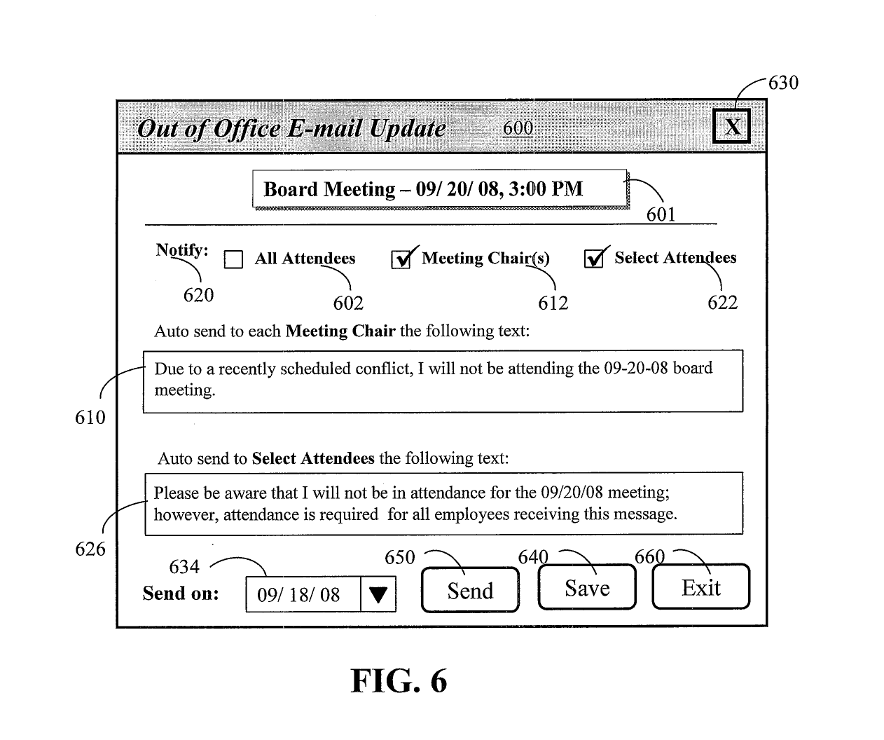

A client may elect to notify two separate sets of recipients with two different messages, in regards to the same event. FIG. 6 illustrates out of office e-mail update alternative GUI 600, wherein one or more message boxes may be displayed for the same meeting. Out of office e-mail update alternative GUI 600 comprises the event title, date, and time, or board meeting 602, as well as the choice of notifying all attendees 602, meeting chair(s) 612, and/or select attendees 622. Text box A 610 and text box B 626 are also displayed. Send on date 634 allows the client to send the e-mail notice immediately, or any date on or prior to the event. Engaging send 632 will distribute the message or hold the e-mail in a message queue until the date requested for sending. Out of office e-mail update alternative GUI 600 may store the entered information by engaging save 640, deliver the automated e-mail messages via send 650, or depart from out of office e-mail update alternative GUI 600 via exit 660. Selecting close 630 will close office e-mail update alternative GUI 600 without sending the automated e-mail messages.

In one embodiment, meeting chair(s) 612 and select attendees 622 are chosen to be notified of the event update. However, separate messages should be sent to each group of individuals, therefore, for each group selected, a text box is displayed. When meeting chair(s) is selected text box A 610 is displayed. A second group of attendees, select attendees 622, is selected, displaying text box B 626 and then select attendees GUI 500. Send on date 634 is selected to send the e-mail two days prior to the meeting. When send 632 is engaged, the e-mail is sent to a message queue for automated distribution at a later date.

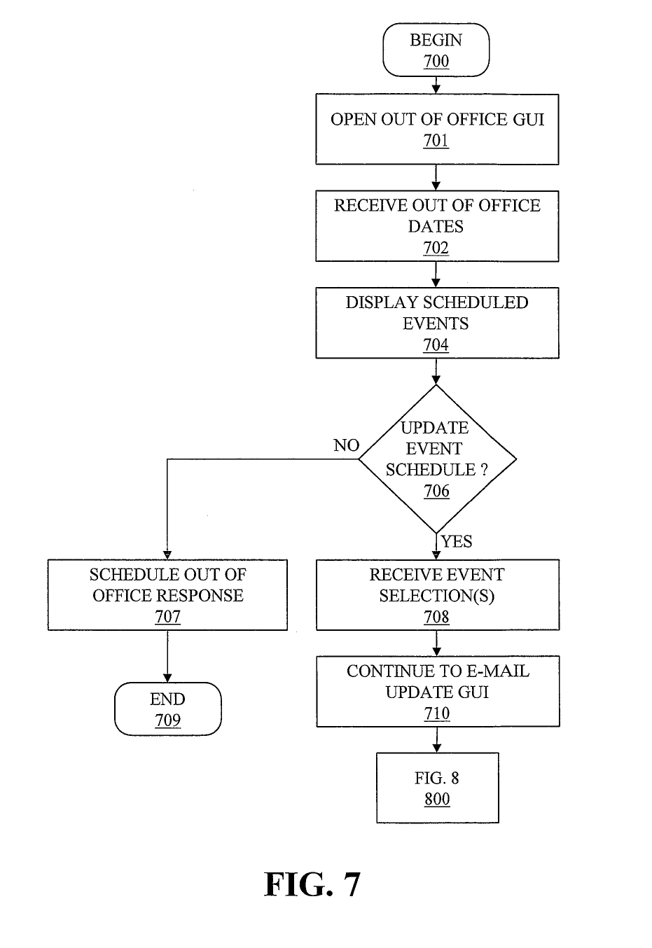

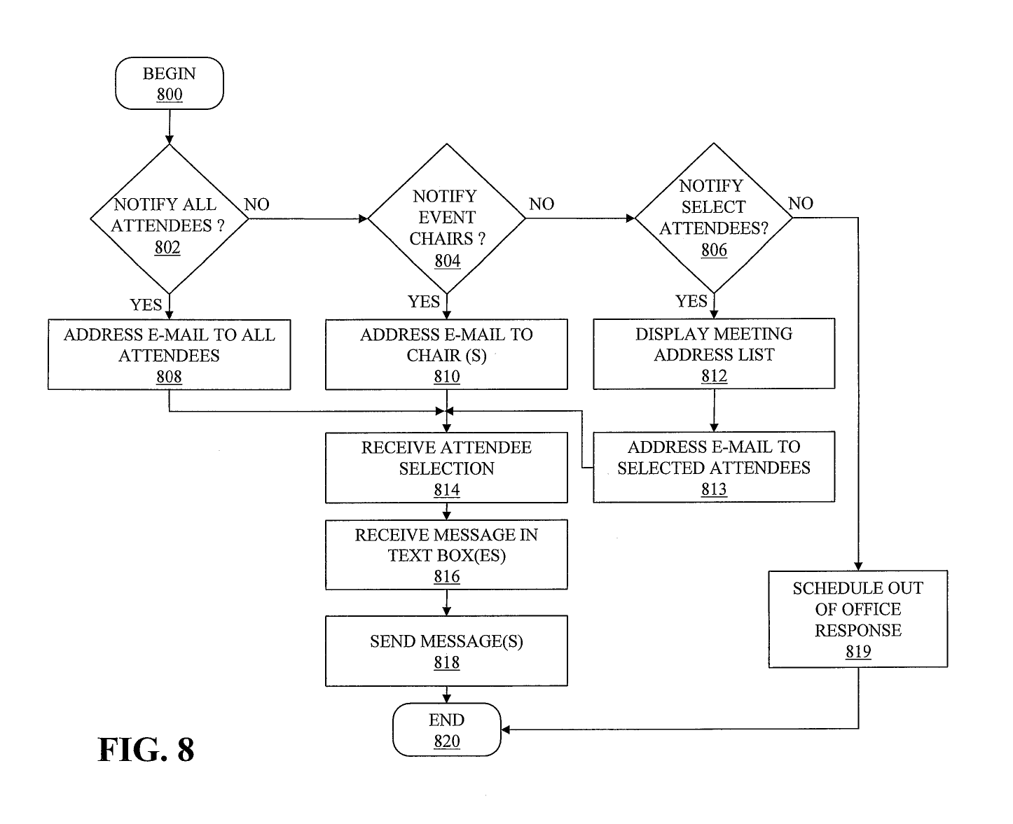

FIGS. 7-8 are flow charts illustrating various methods by which the above processes of the illustrative embodiments are completed. Although the methods illustrated in FIGS. 7-8 may be described with reference to components shown in FIGS. 1-6, it should be understood that this is merely for convenience and alternative components and/or configurations thereof can be employed when implementing the various methods. Key portions of the methods may be completed by AECU utility 140 and MUA 145 executing within DPS 100 (FIG. 1) and controlling specific operations on DPS 100, and the methods are thus described from the perspective of AECU utility 140.

The process of FIG. 7 begins at initiator block 700. At block 701, out of office e-mail options GUI 300 is displayed. At block 702, out of office dates are received, after which conflicting events are automatically displayed at block 704. For each event listed a decision is made at block 706, whether to update the event schedule. If the event is selected to be updated, the event selections are received at block 708. If no event is to be updated, an out of office response is scheduled at block 707, and the process ends at block 709. At block 710, the process continues to out of office e-mail update GUI 400. The process ends at block 712.

The process of FIG. 8 begins at initiator block 800. Out of office e-mail update GUI 400 displays all meetings which were selected in out of office e-mail options GUI 300 to be updated. For each meeting selected a decision is made at block 802, whether to notify all attendees of the event update (cancellation, rescheduling, etc.). If all attendees are selected for notification, the address of all attendees to the event is dynamically linked to the e-mail, at block 808. If there is no selection received to notify all attendees, another decision is made at block 804, whether to notify the event chairs. If the event chairs are selected as recipients of the e-mail, the e-mail address of each chair is dynamically linked to the e-mail at block 810. If there is no selection made to update event chairs, another decision is made at block 806. At block 806, a decision is made whether to notify select attendees. If a selection is made to notify all attendees, select attendees GUI 500 is displayed, at block 812. If there is no selection made to notify select attendees, and no selection made to notify any other groups displayed in out of office e-mail update GUI 400, the basic out of office reply is schedule at block 819, and the process ends at block 820.

AECU utility receives the selections of one or more attendees to notify for one or more events at block 814. At block 816, a message is received in each text box in out of office e-mail update GUI 400. The text received in each text box is embedded in the body of the automated e-mail message and sent to the respective recipients, at block 818. The process ends at block 820. In one embodiment, messages may be sent at select times prior to the event, according to times selected in GUI 600.

In the flow charts above, one or more of the methods are embodied in a computer readable medium containing computer readable code such that a series of steps are performed when the computer readable code is executed on a computing device. In some implementations, certain steps of the methods are combined, performed simultaneously or in a different order, or perhaps omitted, without deviating from the spirit and scope of the invention. Thus, while the method steps are described and illustrated in a particular sequence, use of a specific sequence of steps is not meant to imply any limitations on the invention. Changes may be made with regards to the sequence of steps without departing from the spirit or scope of the present invention. Use of a particular sequence is therefore, not to be taken in a limiting sense, and the scope of the present invention is defined only by the appended claims.

As will be further appreciated, the processes in embodiments of the present invention may be implemented using any combination of software, firmware or hardware. As a preparatory step to practicing the invention in software, the programming code (whether software or firmware) will typically be stored in one or more machine readable storage mediums such as fixed (hard) drives, diskettes, optical disks, magnetic tape, semiconductor memories such as ROMs, PROMs, etc., thereby making an article of manufacture in accordance with the invention. The article of manufacture containing the programming code is used by either executing the code directly from the storage device, by copying the code from the storage device into another storage device such as a hard disk, RAM, etc., or by transmitting the code for remote execution using transmission type media such as digital and analog communication links. The methods of the invention may be practiced by combining one or more machine-readable storage devices containing the code according to the present invention with appropriate processing hardware to execute the code contained therein. An apparatus for practicing the invention could be one or more processing devices and storage systems containing or having network access to program(s) coded in accordance with the invention.

Thus, it is important that while an illustrative embodiment of the present invention is described in the context of a fully functional computer (server) system with installed (or executed) software, those skilled in the art will appreciate that the software aspects of an illustrative embodiment of the present invention are capable of being distributed as a program product in a variety of forms, and that an illustrative embodiment of the present invention applies equally regardless of the particular type of media used to actually carry out the distribution. By way of example, a non exclusive list of types of media, includes recordable type (tangible) media such as floppy disks, thumb drives, hard disk drives, CD ROMs, DVDs, and transmission type media such as digital and analogue communication links.

While the invention has been described with reference to exemplary embodiments, it will be understood by those skilled in the art that various changes may be made and equivalents may be substituted for elements thereof without departing from the scope of the invention. In addition, many modifications may be made to adapt a particular system, device or component thereof to the teachings of the invention without departing from the essential scope thereof. Therefore, it is intended that the invention not be limited to the particular embodiments disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. A method comprising:
detecting a setup within a mail user agent (MUA) of a first type of notification having an associated first time period during which the notification is issued;
dynamically retrieving one or more scheduled calendar events having one or more attendees, which events are scheduled to occur within respective one or more second time periods that overlap with at least one portion of the first time period; and
automatically generating one or more automated e-mails addressed to one or more attendees of at least one of the one or more scheduled calendar events in response to the overlap.

2. The method of claim 1, said automatically generating further comprising:
dynamically retrieving one or more e-mail addresses corresponding to the one or more attendees of the scheduled calendar event;
enabling selective paring of the one or more e-mail addresses to provide a final set of addresses corresponding to the one or more attendees selected to receive the automated e-mail; and
automatically addressing the automated e-mail to the final set of addresses, wherein when no selective paring is received, the automated e-mail is addressed to all attendees of the one or more scheduled calendar events.

3. The method of claim 1, further comprising:
generating a first interface in which is provided a first listing of the one or more scheduled calendar events;
receiving a first selection of one or more of the scheduled calendar events, whose attendees are to be provided an automated e-mail; and
transmitting the automated e-mail to the attendees of a selected one or more of the scheduled calendar events based on the first selection.

4. The method of claim 3, further comprising:
providing a second listing of all classes of attendees associated with one or more scheduled calendar events;
for a selected one of the scheduled calendar events, receiving a second selection of one or more classes of attendees from among all classes of attendees to provide the automated e-mail; and
forwarding the automated e-mail to only the class(es) of attendees selected from among the all classes of attendees, based on the second selection.

5. The method of claim 3, further comprising:
receiving a third selection of specific attendees from among a list of attendees; and
forwarding the automated e-mail to only those specific attendees identified by the third selection.

6. The method of claim 3, further comprising:
receiving a fourth selection to provide different e-mails to different ones of selected attendees;
providing a different text entry box for separate entry of content to be included in the different e-mails; and
transmitting the different e-mails to the different ones of the selected attendees.

7. The method of claim 3, further comprising:
providing a text entry box associated with at least one of the one or more scheduled calendar events;
enabling receipt within the text entry box of additional content to be included within the automated e-mail;
inserting the additional content from within the text entry box into the automated e-mail; and
forwarding the automated e-mail with the additional content inserted therein.

8. The method of claim 3, further comprising:
receiving an entry of a transmission time for transmitting the automated e-mail to the one or more attendees of the selected one or more of the scheduled calendar events; and
buffering the automated e-mail for automatic transmission at the transmission time.

9. The method of claim 1, wherein:
the first type of notification is an out of office e-mail notification and the one or more automated e-mails provide the one or more attendees with information corresponding to an out-of-office status during at least a portion of the second time period; and
said automatically generating further comprises:
detecting one or more attendees associated with one or more schedule calendar events during the out of office period; and
dynamically linking the e-mail addresses of the one or more attendees to one or more of the automated outgoing e-mails.

10. A computer program product comprising:
a computer readable medium; and
program code on the computer readable medium that when executed by a processor provides the functions of:
detecting a setup within a mail user agent (MUA) of a first type of notification having an associated first time period during which the notification is issued;
dynamically retrieving one or more scheduled calendar events having one or more attendees, which events are scheduled to occur within respective one or more second time periods that overlap with at least one portion of the first time period; and
automatically generating one or more automated e-mails addressed to one or more attendees of at least one of the one or more scheduled calendar events in response to the overlap.

11. The computer program product of claim 10, said program code for automatically generating further comprises code for:
dynamically retrieving one or more e-mail addresses corresponding to the one or more attendees of the scheduled calendar event;
enabling selective paring of the one or more e-mail addresses to provide a final set of addresses corresponding to the one or more attendees selected to receive the automated e-mail; and
automatically addressing the automated e-mail to the final set of addresses, wherein when no selective paring is received, the automated e-mail is addressed to all attendees of the one or more scheduled calendar events.

12. The computer program product of claim 10, further comprising code for:
generating a first interface in which is provided a first listing of the one or more scheduled calendar events;
receiving a first selection of one or more of the scheduled calendar events, whose attendees are to be provided an automated e-mail; and
transmitting the automated e-mail to the attendees of a selected one or more of the scheduled calendar events based on the first selection.

13. The computer program product of claim 12, further comprising code for:
providing a second listing of all classes of attendees associated with one or more scheduled calendar events;
for a selected one of the scheduled calendar events, receiving a second selection of one or more classes of attendees from among all classes of attendees to provide the automated e-mail; and
forwarding the automated e-mail to only the class(es) of attendees selected from among the all classes of attendees, based on the second selection.

14. The computer program product of claim 12, further comprising code for:
receiving a third selection of specific attendees from among a list of attendees; and
forwarding the automated e-mail to only those specific attendees identified by the third selection.

15. The computer program product of claim 12, further comprising code for:
receiving a fourth selection to provide different e-mails to different ones of selected attendees;
providing a different text entry box for separate entry of content to be included in the different e-mails; and
transmitting the different e-mails to the different ones of the selected attendees.

16. The computer program product of claim 12, further comprising code for:
providing a text entry box associated with at least one of the one or more scheduled calendar events;
enabling receipt within the text entry box of additional content to be included within the automated e-mail;
inserting the additional content from within the text entry box into the automated e-mail; and
forwarding the automated e-mail with the additional content inserted therein.

17. The computer program product of claim 12, further comprising code for:
receiving an entry of a transmission time for transmitting the automated e-mail to the one or more attendees of the selected one or more of the scheduled calendar events; and
buffering the automated e-mail for automatic transmission at the transmission time.

18. The computer program product of claim 10, wherein:
the first type of notification is an out of office e-mail notification and the one or more automated e-mails provide the one or more attendees with information corresponding to an out-of-office status during at least a portion of the second time period; and
said code for automatically generating further comprises code for:
detecting one or more attendees associated with one or more schedule calendar events during the out of office period; and
dynamically linking the e-mail addresses of the one or more attendees to one or more of the automated outgoing e-mails.

19. A computing device comprising:
a processor;
a mail user agent (MUA);
a calendaring function;
communication means for connecting to an external device to transmit an e-mail generated by the MUA;
a utility executing on the processor in conjunction with the MUA and the calendaring function and which includes program code the provides the functions of:
detecting a setup within a mail user agent (MUA) of a first type of notification having an associated first time period during which the notification is issued;
dynamically retrieving one or more scheduled calendar events having one or more attendees, which events are scheduled to occur within respective one or more second time periods that overlap with at least one portion of the first time period; and
automatically generating one or more automated e-mails addressed to one or more attendees of at least one of the one or more scheduled calendar events in response to the overlap, wherein said automatically generating includes:
dynamically retrieving one or more e-mail addresses corresponding to the one or more attendees of the scheduled calendar event;
enabling selective paring of the one or more e-mail addresses to provide a final set of addresses corresponding to the one or more attendees selected to receive the automated e-mail; and
automatically addressing the automated e-mail to the final set of addresses, wherein when no selective paring is received, the automated e-mail is addressed to all attendees of the one or more scheduled calendar events.

20. The computing device of claim 19, said utility further comprising code for:
generating a first interface in which is provided a first listing of the one or more scheduled calendar events;
receiving a first selection of one or more of the scheduled calendar events, whose attendees are to be provided an automated e-mail;
transmitting the automated e-mail to the attendees of a selected one or more of the scheduled calendar events based on the first selection;
providing a second listing of all classes of attendees associated with one or more scheduled calendar events;
for a selected one of the scheduled calendar events, receiving a second selection of one or more classes of attendees from among all classes of attendees to provide the automated e-mail;
forwarding the automated e-mail to only the class(es) of attendees selected from among the all classes of attendees, based on the second selection;
receiving a third selection of specific attendees from among a list of attendees;
forwarding the automated e-mail to only those specific attendees identified by the third selection;
receiving a fourth selection to provide different e-mails to different ones of selected attendees;
providing a different text entry box for separate entry of content to be included in the different e-mails; and
transmitting the different e-mails to the different ones of the selected attendees.
providing a text entry box associated with at least one of the one or more scheduled calendar events;
enabling receipt within the text entry box of additional content to be included within the automated e-mail;
inserting the additional content from within the text entry box into the automated e-mail;
forwarding the automated e-mail with the additional content inserted therein.
receiving an entry of a transmission time for transmitting the automated e-mail to the one or more attendees of the selected one or more of the scheduled calendar events; and
buffering the automated e-mail for automatic transmission at the transmission time.
